(19) United States
(12) Patent Application Publication
(10) Pub. No.: US 2024/0258871 A1
(43) Pub. Date: Aug. 1, 2024

(54) BRUSHLESS MOTOR

(71) Applicant: Dyson Technology Limited, Wiltshire (GB)

(72) Inventors: Ross Dagnal GOODWIN, Bristol (GB); Colin Paul CHAPMAN, Belper (GB); Japhet Lee Cordova MORABE, Singapore (SG); Guiqin LIU, Singapore (SG); Hengky WIRAWAN, Singapore (SG); Shermaine Yvonne TAN, Singapore (SG)

(73) Assignee: Dyson Technology Limited, Wiltshire (GB)

(21) Appl. No.: 18/578,506

(22) PCT Filed: Jul. 12, 2022
(86) PCT No.: PCT/GB2022/051806

§ 371 Date: Jan. 11, 2024

(30) Foreign Application Priority Data
Jul. 13, 2021 (GB) 2110080.5
Jul. 13, 2021 (GB) 2110081.3
Jul. 13, 2021 (GB) 2110082.1
Jul. 13, 2021 (GB) 2110085.4
Jul. 8, 2022 (GB) 2210024.2

(51) Int. Cl. H02K 5/20; A47L 5/28; A47L 9/28; H02K 1/14; H02K 3/52; H02K 7/08; H02K 21/16

(52) U.S. Cl. CPC H02K 5/207; A47L 5/28; A47L 9/2889; H02K 1/148; H02K 3/522; H02K 7/083; H02K 21/16; H02K 2203/12

(57) ABSTRACT

A brushless motor has a stator assembly, a rotor assembly, and a frame within which the stator assembly is housed. The stator assembly has a plurality of stator core sub-assemblies each including a stator core, a bobbin attached to the stator core, and a winding wound about the bobbin. The frame is overmoulded to the stator assembly. The frame includes a plurality of apertures for introducing airflow to the rotor assembly in use.

### FIELD OF THE INVENTION

The present invention relates to a brushless motor, and to a method of manufacturing a brushless motor.

### BACKGROUND OF THE INVENTION

There is a general desire to improve electric machines, such as brushless motors, in a number of ways. For example, improvements may be desired in terms of size, weight, power density, manufacturing cost, efficiency, reliability, and noise.

### SUMMARY OF THE INVENTION

According to a first aspect of the present invention there is provided a brushless motor comprising a stator assembly, a rotor assembly, and a frame within which the stator assembly is housed, wherein the stator assembly comprises a plurality of stator core sub-assemblies each comprising a stator core, a bobbin attached to the stator core, and a winding wound about the bobbin, wherein the frame is overmoulded to the stator assembly; the frame comprises a plurality of apertures for introducing airflow to the rotor assembly in use.

The frame comprises a plurality of apertures for introducing airflow to the rotor assembly, for example into the channel, in use. This may provide a cooling airflow to the rotor assembly, for example to the permanent magnet of the rotor assembly, through the channel, in use. The plurality of apertures may comprise pairs of respective inlet and outlet apertures, inlet apertures located at an inlet end of the frame, and outlet apertures located at an outlet end of the frame. Inlet apertures may be located downstream of the first bearing, and outlet apertures may be located upstream of the second bearing.

The brushless motor may comprise each stator core comprising a back and first and second arms extending from the back.

The brushless motor may be advantageous as overmoulding the frame to the stator assembly may, for example, remove the need for the stator core sub-assemblies to be individually adhered to the frame, and may provide a manufacturing process with fewer steps than a manufacturing process in which the stator core sub-assemblies are individually adhered to the frame. Overmoulding the frame to the stator assembly may, in some examples, provide increased thermal transfer from the stator core sub-assemblies to the frame compared to embodiments where stator core sub-assemblies are adhered to the frame.

Overmoulding the frame to the stator assembly may provide a brushless motor having a greater overall stiffness than, for example, a brushless motor in which the stator core sub-assemblies are individually adhered to the frame.

However, overmoulding of the stator core sub-assemblies may remove the stator core sub-assemblies from a region of airflow through the brushless motor in use, which may result in the stator cores and/or the windings experiencing increased temperatures in use.

By overmoulding the frame to the stator assembly such that at least a portion of the back and the first and second arms of each stator core is exposed through the frame, at least a portion of each stator core may be exposed to airflow through the brushless motor in use, which may provide a cooling effect, thereby reducing any increases in temperature experienced as a result of the overmoulding of the stator assembly.

Each stator core may be generally C-shaped in form, and shoulders, for example regions of transition from the back to the first and second arms, of each C-shaped stator core may be exposed through the frame. Use of separate C-shaped stator cores, which are individually wound, may allow for a relatively high winding fill factor.

At least 10% of each stator core may be exposed through the frame. This may provide sufficient cooling of the stator cores in use.

No more than 30% of each stator core may be exposed through the frame. This may provide an arrangement with adequate frame stiffness whilst still exposing the stator cores to airflow through the brushless motor in use, which may provide enhanced cooling of the stator cores.

The frame may be overmoulded to the stator assembly such that pole faces of the stator cores are exposed, for example defining part of a boundary wall of a channel within which a rotor assembly is located. This may provide improved flux linkage between the pole faces and a permanent magnet of the rotor assembly compared to, for example, an arrangement where the pole faces are overmoulded.

The brushless motor may comprise a rotor assembly rotatable relative to the stator assembly. The rotor assembly may comprise a shaft, a permanent magnet attached to the shaft, a first bearing attached to a first end of the shaft, and a second bearing attached to a second end of the shaft opposite to the first end of the shaft. The frame may define first and second bearing seats for the respective first and second bearings, and a channel within which the permanent magnet is located. In such a manner the frame may define a support structure within which the rotor assembly is located and held.

The rotor assembly may comprise an impeller for generating an airflow upon rotation of the rotor assembly, and the frame may define a shroud for the impeller. Using the overmoulded frame to define a shroud may provide reduced component count relative to an arrangement where the frame and the shroud comprise separate components.

The frame may comprise a thermoplastic material. The frame may comprise a material having a thermal conductivity, for example a through-plane thermal conductivity, of at least 1.5 W/mK. The frame may comprise a material having a Young's modulus in the region of 10-45 GPa, for example in the region of 25 GPa.

The frame may comprise a plurality of turbulators, for example a plurality of projections for generating vortices in airflow through the brushless motor in use. Creation of such vortices may provide improved thermal transfer away from the stator cores in use.

The turbulators may be formed during a process of overmoulding the frame to the stator assembly. Integrally forming the turbulators with the frame as part of the same overmoulding process may reduce a risk of separation of the turbulators from the frame in use compared to, for example, an arrangement in which the turbulators are adhered to the frame. Integrally forming the turbulators with the frame as part of the same overmoulding process may reduce the number of steps in manufacturing the brushless permanent magnet.

The plurality of turbulators may overlie the backs of the stator cores, for example overlying windings disposed on the backs of the stator cores. This may generate vortices in the region of the backs of the stator cores, which may aid with heat transfer away from the backs of the stator cores, for example heat transfer away from windings disposed on the backs of stator cores, in use.

The plurality of turbulators may be obliquely angled relative to an axis substantially parallel to a central longitudinal axis of the brushless motor. This may provide a compromise between generated vortices and generally laminar airflow through the brushless motor in use. The central longitudinal axis of the brushless motor may extend from an inlet end of the brushless motor to an outlet end of the brushless motor, and may, for example be located centrally through the shaft of the rotor assembly.

The plurality of turbulators may be angled between 45-75 degrees relative to the axis, for example at around 60 degrees relative to the axis. This may be particularly effective at generating vortices for appropriate heat transfer away from the backs of the stator cores. The angle may be measured between a trailing end of each turbulator, for example an end of each turbulator that is furthest toward the impeller, and the axis. The trailing end of each turbulator may be closer to the axis than a leading end of the turbulator.

The trailing end of each turbulator may be closer to the axis than a leading end of the turbulator.

A pitch to height ratio of each turbulator may be in the region of 6:1 to 12:1, for example around 7:1. This may be particularly effective at generating vortices for appropriate heat transfer away from the backs of the stator cores. A height of each turbulator may be in a region of 0.3 mm to 0.9 mm, for example around 0.6 mm. This may provide a cooling effect without significantly choking airflow through the brushless motor in use.

The plurality of turbulators may comprise a plurality of pairs of turbulators, each pair of turbulators arranged in a generally V-shaped formation. This may be particularly effective at generating vortices for appropriate heat transfer away from the backs of the stator cores. A first turbulator of a pair of turbulators may be arranged on a first side of a core back, and a second turbulator of the pair of turbulators may be arranged on a second side of the core back.

The frame may comprise a main body having protrusions, each protrusion overlying a respective stator core, and each protrusion comprising a region of increased radius relative to regions of the main body between adjacent stator cores of the stator assembly. This may provide a reduced thickness volume of material covering the stator assembly in the regions between adjacent stator cores compared to, for example, an arrangement where the frame has a constant radius whilst overlying the stator cores. The main body may be generally cylindrical in form, with the protrusions extending outwardly therefrom.

The frame may comprise a plurality of struts, each strut extending from a respective region of the frame overlying a core back to the shroud. The plurality of struts may act as a heat sink, which may provide increased cooling of the stator core and/or windings in use. The plurality of struts may each overlie a respective winding. A leading end of each strut may be substantially aligned with a leading edge of a winding which the strut overlies. This may ensure that the heat sink provided by the strut is located in substantially the same position as the heat source, ie the windings. The leading end of each strut may comprise an aerodynamically shaped surface. Each strut may be located between the first and second turbulators of a pair of turbulators.

In some examples each turbulator may comprise a generally v-shaped turbulator. The frame may comprise a plurality of generally v-shaped turbulators located either side of the struts.

According to a second aspect of the present invention there is provided a vacuum cleaner comprising a brushless motor according to the first aspect of the present invention.

According to a third aspect of the present invention there is provided a method of manufacturing a brushless motor, the method comprising: obtaining a plurality of stator core sub-assemblies each comprising a stator core, a bobbin attached to the stator core, and a winding wound about the bobbin, each stator core comprising a back and first and second arms extending from the back; and overmoulding the plurality of stator core sub-assemblies to define a frame within which the plurality of stator core sub-assemblies are housed such that at least a portion of the back and the first and second arms of each stator core is exposed through the frame.

The method according to the third aspect of the present invention may be advantageous as overmoulding the frame to the plurality of stator core sub-assemblies may, for example, remove the need for the stator core sub-assemblies to be individually adhered to the frame, and may provide a manufacturing process with fewer steps than a manufacturing process in which the stator core sub-assemblies are individually adhered to the frame. Overmoulding the frame to the plurality of stator core sub-assemblies may, in some examples, provide increased thermal transfer from the stator core sub-assemblies to the frame compared to embodiments where stator core sub-assemblies are adhered to the frame.

Overmoulding the frame to the stator assembly may provide a brushless motor having a greater overall stiffness than, for example, a brushless motor in which the stator core sub-assemblies are individually adhered to the frame. Overmoulding the frame to the stator assembly may also facilitate manufacture of a brushless motor having a generally sealed bearing cartridge compared to, for example, an arrangement where the frame has apertures into which individual stator core sub-assemblies are mounted. A sealed bearing cartridge may inhibit airflow from entering the region of the frame in which the bearings are housed in use, which may reduce emissions.

However, overmoulding of the stator core sub-assemblies may remove the stator core sub-assemblies from a region of airflow through the brushless motor in use, which may result in the stator cores and/or the windings experiencing increased temperatures in use. By overmoulding the frame to the plurality of stator core sub-assemblies such that at least a portion of the back and the first and second arms of each stator core is exposed through the frame, at least a portion of each stator core may be exposed to airflow through the brushless motor in use, which may provide a cooling effect, thereby reducing any increases in temperature experienced as a result of the overmoulding of the stator assembly.

The method may comprise inserting a rotor assembly into a channel defined by the frame such that the rotor assembly is rotatable relative to the plurality of stator core sub-assemblies.

The method may comprise forming turbulators of the frame during the process of overmoulding the plurality of stator core sub-assemblies to define the frame. The turbulators may create vortices in airflow through the brushless motor in use, thereby providing improved thermal transfer away from the stator cores in use, whilst integrally forming the turbulators with the frame as part of the same overmoulding process may reduce the number of steps in manufacturing the brushless motor.

The method may comprise forming struts of the frame during the process of overmoulding the plurality of stator core sub-assemblies to define the frame, each strut extending from a respective region of the frame overlying a core back to a shroud of the frame. The struts may act as a heat sink, which may provide increased cooling of the stator core and/or windings in use, whilst forming the struts with the frame as part of the same overmoulding process may reduce the number of steps in manufacturing the brushless motor.

According to a fourth aspect of the present invention there is provided a brushless motor comprising a stator assembly, and a frame within which the stator assembly is housed, wherein the stator assembly comprises a plurality of stator core sub-assemblies each comprising a stator core, a bobbin attached to the stator core, and a winding wound about the bobbin, each stator core comprising a back and first and second arms extending from the back, wherein the frame is overmoulded to the stator assembly such that the frame comprises a plurality of turbulators overlying the backs of the stator cores.

Optional features of aspects of the present invention may be equally applied to other aspects of the present invention, where appropriate.

### BRIEF DESCRIPTION OF THE DRAWINGS

FIG. 1 is a perspective view of a brushless permanent magnet motor;

FIG. 2 is a perspective view of a stator assembly of the brushless permanent magnet motor of FIG. 1;

FIG. 3 is a perspective view of a plurality of stator core sub-assemblies of the stator assembly of FIG. 2;

FIG. 4 is a perspective view of a termination assembly of the stator assembly of FIG. 2;

FIG. 5 is a perspective view of a single stator core sub-assembly of the stator assembly of FIG. 2;

FIG. 6 is a cross-sectional view through the stator core sub-assembly of FIG. 5;

FIG. 7 is a perspective view of a rotor assembly of the brushless permanent magnet motor of FIG. 1;

FIG. 8 is a cross-sectional view through the brushless permanent magnet motor of FIG. 1;

FIG. 9 is a cross-sectional view through the brushless permanent magnet motor of FIG. 1 with the rotor assembly and diffuser removed;

FIG. 10 is a perspective view of an end cap of the brushless permanent magnet motor of FIG. 1;

FIG. 11 is an enlarged cross-sectional view of an inlet end of the brushless permanent magnet motor of FIG. 1;

FIG. 12 is a flow diagram illustrating a first method of manufacturing a brushless permanent magnet motor;

FIG. 13 is a flow diagram illustrating a second method of manufacturing a brushless permanent magnet motor; and

FIG. 14 is a schematic perspective view of a vacuum cleaner incorporating the brushless permanent magnet motor of FIG. 1.

### DETAILED DESCRIPTION OF THE INVENTION

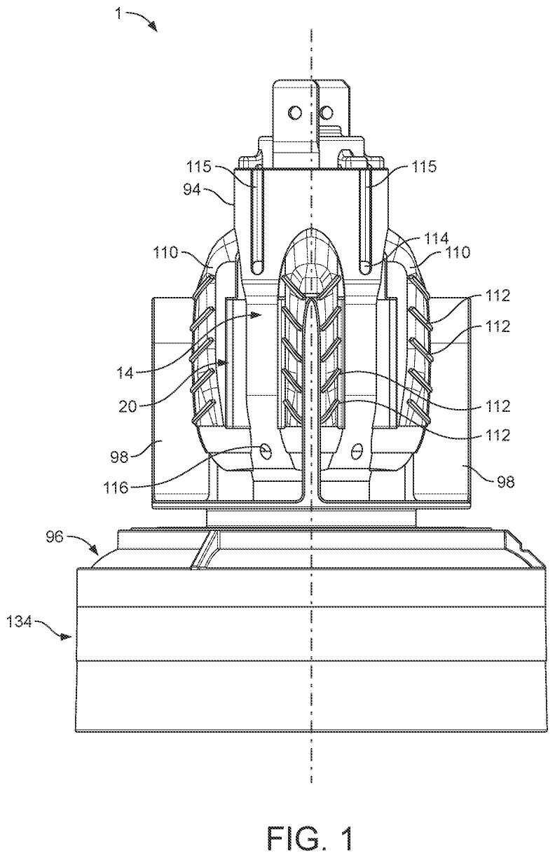

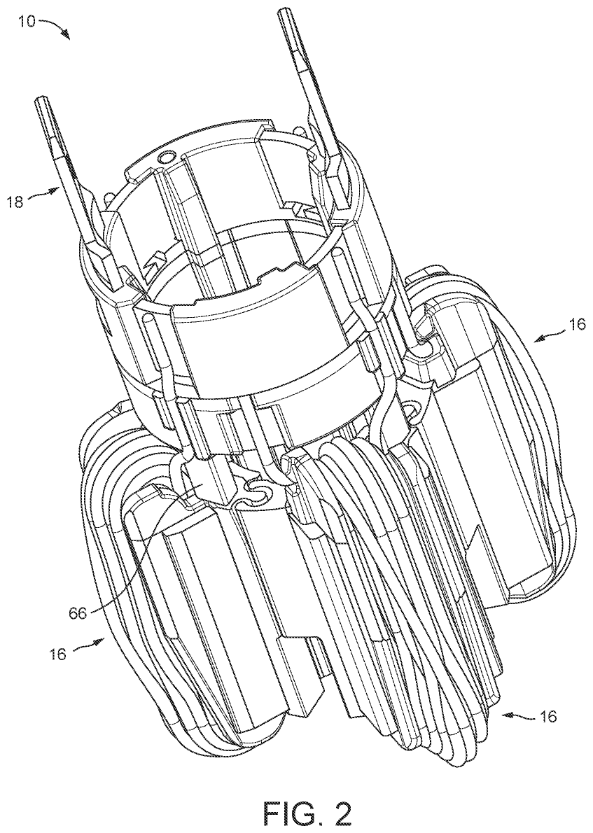

A brushless permanent magnet motor according to the present invention, generally designated 1, is illustrated in FIG. 1, with components of the brushless permanent magnet motor illustrated in FIGS. 2 to 7. Although described here in relation to a brushless permanent magnet motor, it will be appreciated by a person skilled in the art that at least some of the teachings disclosed herein may be applicable to other types of brushless motor.

The brushless permanent magnet motor comprises a stator assembly 10, a rotor assembly 12, and a frame 14.

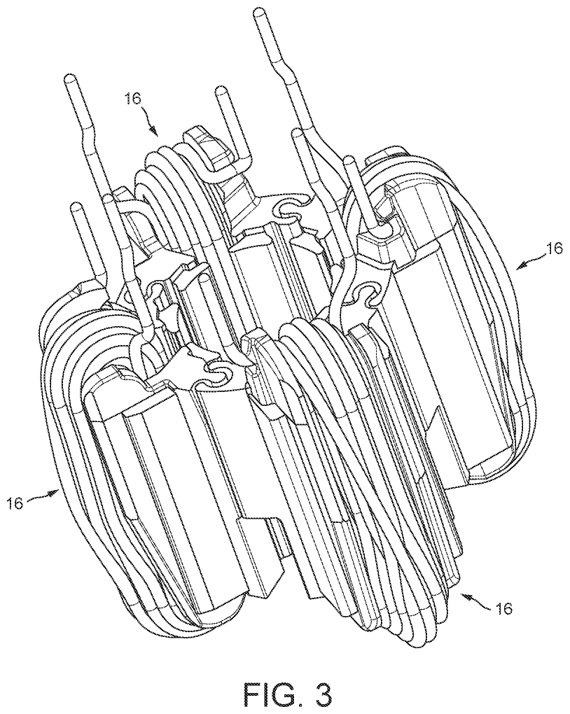

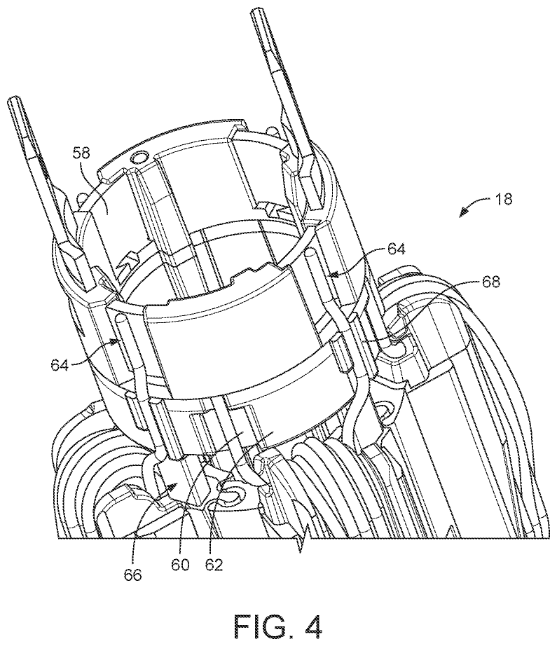

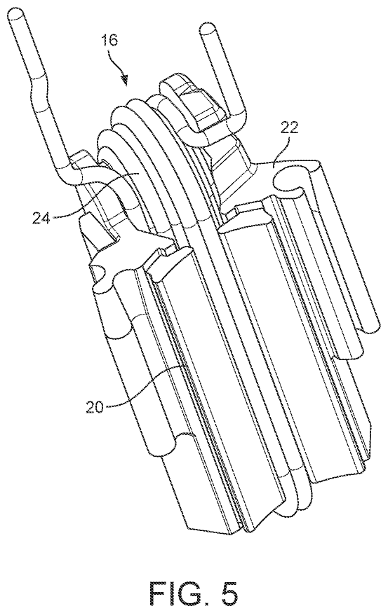

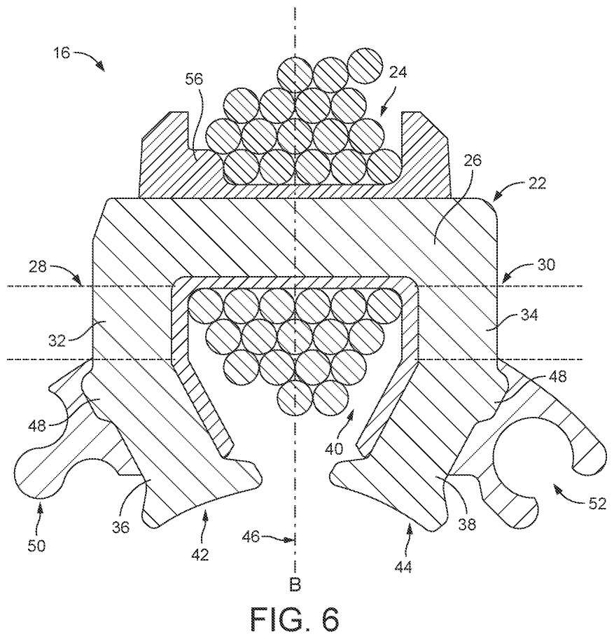

The stator assembly 10 is illustrated in isolation in FIG. 2, and comprises four stator core sub-assemblies 16 and a termination assembly 18. The four stator core sub-assemblies are shown connected in FIG. 3, with the termination assembly 18 shown in isolation in FIG. 4. An individual stator core sub-assembly 16 can be seen in FIGS. 5 and 6, and it will be appreciated that each stator core sub-assembly 16 has substantially the same structure.

The stator core sub-assembly 16 comprises a stator core 20, a bobbin 22, and a winding 24 wound about the bobbin 22. The stator core 20 has a back 26, and first 28 and second 30 arms extending from the back 26. The stator core 20 has a generally C-shaped form, and may be referred to as a c-core. The first 28 and second 30 arms each comprise a respective first portion 32,34 and a respective second portion 36,38. Each first portion 32,34 extends substantially orthogonally from the back 26, and each second portion 36,38 is angled at around 28 degrees relative to the respective first portion 32,34. Each second portion 36,38 is around 2 times the length of the respective first portion 32,34.

The second portions 36,38 are angled inwardly toward one another, and collectively the back 26 and the first 28 and second 30 arms define a winding channel 40 within which the winding 24 is located. Given the relative orientations of the back 26 and the first 28 and second 30 arms, the winding channel 40 has a generally trapezoidal cross-sectional area, as seen in FIG. 6. It has been found that provision of a generally trapezoidal winding channel 40 may enable a winding pattern of the winding 24 that achieves a relatively high fill factor, whilst angling the second portions 36,38 of the first 28 and second 30 arms inwardly toward one another may reduce a height of the stator core 20.

The stator core 20 comprises pole faces 42,44 disposed at ends of the respective second portions 36,38, with the pole faces 42,44 extending to either side of the respective second portions 36,38. The pole faces 42,44 are spaced apart from one another to define a slot gap 46, with the slot gap 46 defining a point of entry into the winding channel 40. The pole faces 42,44 are asymmetric to provide saliency, and are curved with each pole face 42,44 having a different center of curvature. The asymmetry of the pole faces 42,44 results in different distances from each pole face 42,44 to a centre line B of the slot gap 46. Each pole face 42,44 is asymmetric relative to the other pole face 44,42, but each individual pole face 42,44 is also asymmetric about a center line of that pole face.

To maximise flux linkage between the stator core 20 and the rotor assembly 12 in use, it may be desirable for the pole faces 42,44 to be as wide as possible. However, increasing the width of the pole faces 42,44 in an inward direction may reduce a width of the slot gap 46, making winding of the stator core 20 difficult. Increasing the width of the pole faces 42,44 in an outward direction may increase flux leakage between adjacent stator cores 20 in the stator assembly 10. To provide a compromise between these competing factors, a ratio of the combined width of the pole faces 42,44 to the width of the slot gap 46 is in the region of 3:1 to 7:1.

The stator core 20 is formed of a plurality of laminations, each having the form previously described. A protrusion 48 is located on an outer surface of each second portion 36,38, with the protrusions 48 being used to weld the laminations together to form the stator core 20. In other examples, the laminations are glued together rather than welded. The back 26 is asymmetric about the centre line B of the slot gap, which enables correct orientation of the stator core 20 during manufacture.

The bobbin 22 is overmoulded to the stator core 20, such that the bobbin 22 overlies inner and outer surfaces of the back 26, inner surfaces of the first portions 32,34 of the first 28 and second 30 arms, and inner and outer surfaces of the second portions 36,28 of the first 28 and second 30 arms. The bobbin 22 thereby lines the winding channel 40, and allows the winding 24 to be wound about the back 26 of the stator core 20. Overmoulding the bobbin 22 to the stator core 20 enables the bobbin to have a wall thickness in the region of 0.4 mm in the winding channel 40, which may maximise the available cross-sectional area to be filled with the winding 24.

The bobbin 22 is overmoulded to the stator core 20 such that shoulders of the stator core 20, ie portions of the stator core the bridge the back 26 and the first portions 32,34 of the first 28 and second 30 arms, are exposed, and such that the pole faces 42,44 are exposed, for reasons that will be discussed hereafter.

A region of the bobbin 22 on an outer surface of the second portion 36 of the first arm 28 defines a first connection portion 50, and a region of the bobbin 22 on an outer surface of the second portion 38 of the second arm 30 defines a second connection portion 52. The first connection portion 50 comprises a rounded projection that extends partially along the length of the bobbin 22, and the second connection portion 52 comprises a rounded recess that extends partially along the length of the bobbin 22. The first 50 and second 52 connection portions are complementarily shaped, such that adjacent bobbins 22 in the stator assembly 10 can be connected to one another by axially sliding the relevant connection portions 50,52 together. The connection portions 50,52 allows relative axial movement of connected bobbins 22, whilst inhibiting circumferential and radial separation of the bobbins 22. The connection portions 50,52 enable individual stator core sub-assemblies 16 to be connected together during manufacture, as will be described hereinafter.

As seen in the cross-sectional view of FIG. 6, the bobbin 22 comprises a winding guide 56 located in a region of an outer surface of the back 26. The winding guide 56 serves to guide the winding 24 during winding of the stator core 22.

When wound, as seen in the cross-sectional view of FIG. 6, the winding 24 has a generally trapezoidal form within the winding channel 40. This may provide a relatively high fill factor. The winding 24 is asymmetric about the back 26, with the portion of the winding 24 that overlies an outer surface of the back 26 defining a different cross-sectional shape to the portion of the winding 24 located within the winding channel 40. This may enable a relatively high fill factor within the winding channel 24, whilst still providing flexibility for connection to terminals of the termination assembly 18.

The termination assembly 18 comprises a first, upper, terminal 58, a second, lower, terminal 60, and a sleeve 62. Each of the first 58 and second 60 terminals is generally annular in form, with the first terminal 58 overlying the second terminal 60. The sleeve 62 is overmoulded to the first 58 and second 60 terminals such that the relative positions of the first 58 and second 60 terminals are maintained. The sleeve 62 comprises a plurality of apertures 64 which enable the windings 24 of the stator core sub-assemblies 16 to be connected to the first 58 and second 60 terminals. The sleeve 62 further comprises a plurality of locating features 66 for locating the sleeve 62 relative to the bobbins 22 during manufacture, and wire guides 68 formed on the locating features 66. The locating features 66 are each located adjacent to a corresponding aperture 64.

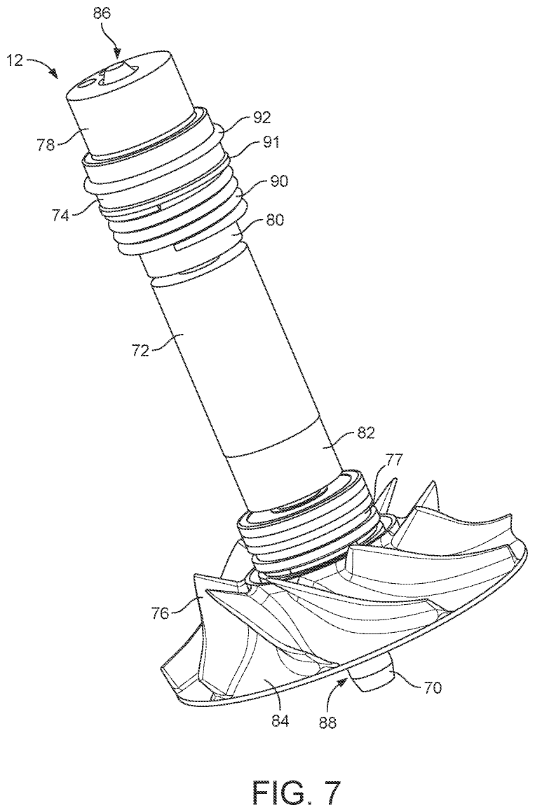

The rotor assembly 12 is shown in isolation in FIG. 7. The rotor assembly 12 comprises a shaft 70, a permanent magnet 72, first 74 and second 76 bearings, first 78, second 80 and third 82 balancing rings, and an impeller 84.

The shaft 70 is elongate in form, having an inlet end 86 and an outlet end 88, with inlet and outlet referring generally to a direction of airflow through the brushless permanent magnet motor 1 in use. The permanent magnet 72 is mounted generally centrally along the shaft 70. The first balancing ring 78 is mounted to the shaft 70 at the inlet end 86, with the first bearing 74 mounted to the shaft 70 adjacent to the first balancing ring 78. The second balancing ring 80 is mounted to the shaft 70 between the first bearing 74 and the permanent magnet 72.

The impeller 84 is mounted to the outlet end 88 of the shaft 70. The second bearing 76 is mounted to the shaft 70 adjacent to the impeller 84, with the third balancing ring 82 mounted to the shaft 70 between the second bearing 76 and the permanent magnet 72. The second bearing 76 comprises annular grooves 77 for receiving adhesive.

The rotor assembly 12 further comprises a pre-load spring 90 for applying a pre-load to the first bearing 74, an annular washer 91 in contact with the pre-load spring 90 and the outer race of the first bearing 74, and an o-ring 92 located about the first bearing 74, as will be discussed in more detail hereinafter.

The frame 14 can be seen in FIGS. 1, 8 and 9, and comprises a main body 94, a shroud 96, and a plurality of struts 98 extending between the main body 94 and the shroud 96. The main body 94 is generally cylindrical in form, defines first 100 and second 102 bearing seats for the respective first 74 and second 76 bearings, and defines a channel 104 within which the rotor assembly 12 is received. The shroud 96 is radially spaced from the main body 94, and has a central aperture that overlies the impeller 84, such that airflow can interact with the impeller 84 in use.

To manufacture the frame 14, the frame 14 is overmoulded to the stator assembly 10 in an overmoulding process. Given the form of the wound stator core sub-assemblies 16, the overmoulding of the frame 14 results in the main body 94 of the frame 14 having protrusions 110 which overlie the windings 24 located on the backs 26 of the stator cores 22. The protrusions 110 are formed such that the shoulders of the stator cores 22 are not covered by the frame 14. This allows the shoulders of the stator cores 22 to be exposed to airflow through the brushless permanent magnet motor 1 in use, which may provide a cooling effect for the stator cores 22. The frame 14 is also overmoulded such that the pole faces 42,44 of the stator cores 22 are exposed to the interior of the channel. Collectively, at least 10% but no more than 30% of each stator core is not covered by the frame 14.

The protrusions 110 define regions of increased radius relative to the regions of the main body 94 that lie between adjacent stator core sub-assemblies. This reduces a volume of material required for the frame 14 compared to a frame that has a constant radius, and may provide improved heat transfer may removing unnecessary frame material.

To aid with heat transfer away from the rotor assembly 12 and the stator assembly 10 in use, the frame 14 is formed from a material having a through-plane thermal conductivity, of at least 1.5 W/mK. To provide strength to the brushless permanent magnet motor 1, the frame comprises a Young's modulus in the region of 10-45 GPa, for example in the region of 25 GPa.

To further aid with heat transfer away from the windings 24, the frame 14 comprises a plurality of turbulators 112 formed on the protrusions 110. Each turbulator 112 is a projection upstanding from a protrusion 110, with the turbulators 112 formed as part of the same overmoulding process that defines the rest of the frame 14. It will be appreciated that in alternative embodiments the turbulators 112 may be formed as separate components to the remainder of the frame 14, and attached to the frame 14 in any appropriate manner, such as via an adhesive or the like.

The turbulators 112 are arranged in pairs along the length of each protrusion 110. Each turbulator 112 is angled at around 60 degrees relative to an axis parallel to a central longitudinal axis of the brushless permanent magnet motor 1, i.e. an axis parallel to the shaft 70. Collectively a pair of turbulators 112 defines a general chevron-like shape, with the chevron-like shape pointing toward the impeller 84. In alternative embodiments, not illustrated here, each turbulator 112 may itself comprise a chevron-shape.

There may be a compromise to be reached in terms of allowing the turbulators 112 to generate vortices in the region of the protrusions 110 to aid with transfer of heat away from the windings 24 of the stator assembly 10 in use, versus avoiding choking airflow through the brushless permanent magnet motor 1 in use. A pitch to height ratio of each turbulator in the region of 7:1 has been found to be an effective compromise, with a height of each turbulator in the region of 0.6 mm, for example around 0.58 mm.

The form of turbulator 112 described above may be effective at generating vortices in the region of the protrusions 110, which overlie the windings 24 on the backs 26 of the stator cores 22, with such vortices aiding with transfer of heat away from the windings 24 of the stator assembly 10 in use.

The struts 98 extend from the protrusions to the shroud 96, such that the struts 98 also overlie the windings 24 on the backs 26 of the stator cores 22. The struts 98 may thereby act as heat sinks for the windings 24, with airflow moving over the struts 98 in use to carry heat away from the struts 98. A leading end of each strut 98 is substantially aligned with a leading edge of a winding 24 that the strut overlies to ensure that the strut 98 is aligned with the appropriate heat source, ie winding 24. The leading end of each strut is aerodynamically shaped, in a curved manner, to promote desirable airflow characteristics through the brushless permanent magnet motor 1 in use.

The main body 94 of the frame 14 comprises a plurality of inlet cooling apertures 114, a plurality of outlet cooling apertures 116, and an adhesive injection aperture (not shown). The plurality of inlet cooling apertures 114 are located in a region below the first bearing seat 100, and are spaced about the periphery of the main body 94. The plurality of inlet cooling apertures 114 are shaped to direct airflow flowing through the brushless permanent magnet motor 1 in use into the channel 104, which provides a cooling effect for the rotor assembly 12. The main body 94 of the frame 14 further comprises a plurality of inlet guide grooves or channels 115 formed in the outer surfaces of the main body 94, with each of these inlet guide grooves 115 being arranged to guide airflow flowing through the brushless permanent magnet motor 1 in use into a respective inlet cooling aperture 114. Each of the plurality of inlet guide grooves 115 extend axially, in a direction parallel to a central longitudinal axis of the brushless permanent magnet motor 1, from the upstream end of the main body 94 of the frame 14 to the respective inlet cooling apertures 114.

The plurality of outlet cooling apertures 116 are located in a region of the second bearing seat 102, and are spaced about the periphery of the main body 94. The plurality of outlet cooling apertures 116 are shaped to direct airflow flowing through the channel 104, outwardly from the frame 14, before the airflow passes through the impeller 84. The adhesive injection aperture allows insertion of adhesive into the annular grooves 77 of the second bearing 76 through the frame 14.

An outlet end of the main body 94 of the frame defines a labyrinth seal with the impeller 84.

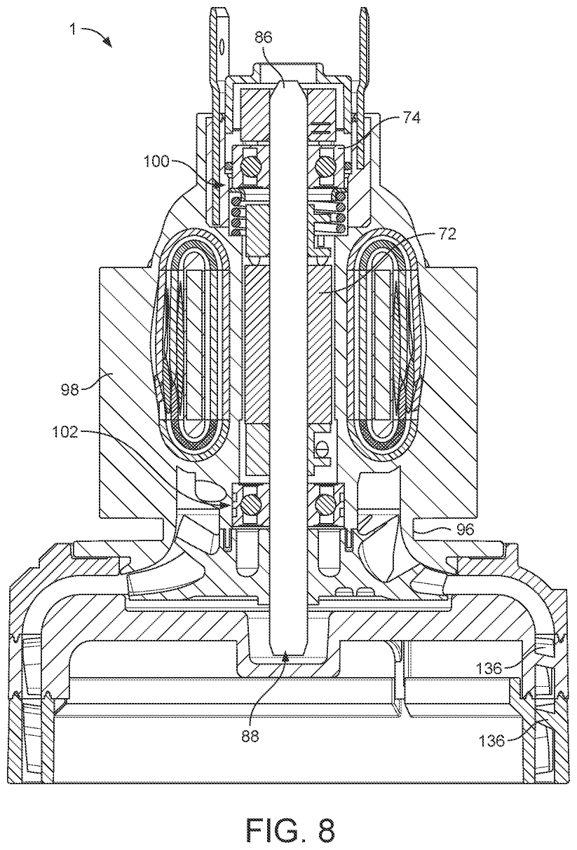

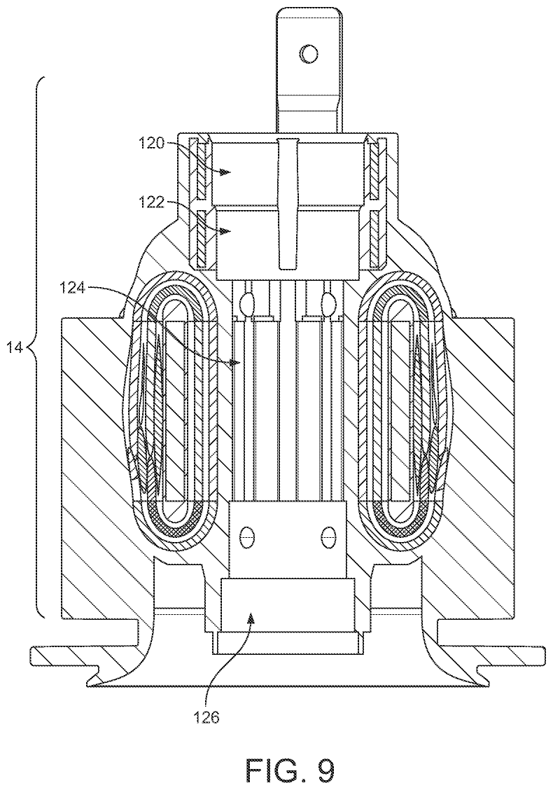

A cross-section through the brushless permanent magnet motor 1 is shown in FIGS. 8 and 9. As can be seen, the rotor assembly 12 sits within the frame 14, with the first bearing 74 located at the first bearing seat 100, the second bearing 76 located at the second bearing seat 102, and the permanent magnet 72 aligned with the stator cores 22 of the stator assembly 10. The second bearing 76 is secured to the second bearing seat 102 by adhesive located in the annular grooves 77 formed on the outer race of the second bearing 76.

The channel 104 of the frame comprises first 120 and second 122 portions of different diameters in the region of the first bearing 74, with the first 120 and second 122 portions collectively defining the first bearing seat 100.

The o-ring 92 is located substantially centrally along the axial length of the first bearing 74. The o-ring 92 sits between the first bearing 74 and the frame 14 in the first portion 120 of the channel 104 such that the o-ring 92 is substantially uncompressed, and has a substantially circular cross-sectional profile. The o-ring has a shore A hardness of around 75, and has a radial stiffness in the region of 1.0×10⁶ N/m to 4.0×10⁶ N/m, for example around 2.5×10⁶ N/m. Providing the o-ring 92 with a relatively high radial stiffness may in turn provide the rotor assembly 12 with a relatively high radial stiffness. This allows the rotor assembly 12 to operate as a sub-critical rotor assembly, and allows the brushless permanent magnet motor 1 to operate in a speed range below all resonant frequencies of the rotor assembly 12. The o-ring 92 has a thermal conductivity of at least 3 W/mK, which may aid with heat transfer away from the first bearing 74 in use.

The low compression of the o-ring 92 between the first bearing 74 and the frame 14 in the first portion 120 of the channel 104, along with the substantially circular cross-sectional profile of the o-ring 92, enables the o-ring 92 to roll axially, in a direction parallel to a central longitudinal axis of the brushless permanent magnet motor 1. This may facilitate pre-loading of the first bearing 74 by the pre-load spring 90 via the annular washer 91. A step change between the first 120 and second 122 portions of the channel 104 defines an axial stop for inhibiting motion of the o-ring 92 toward the impeller 84.

A third portion 124 of the channel 104 has a reduced diameter relative to the first 120 and second 122 portions of the channel 104, with the permanent magnet 72 sitting within the third portion 124 of the channel 104. A step change between the second 122 and third 124 portions of the channel 104 defines a seat for the pre-load spring 90. A fourth portion 126 of the channel 104 has an increased diameter relative to the third portion of the channel 104, with the fourth portion 126 of the channel 104 defining the second bearing seat 102.

Whilst the o-ring 92 is relatively stiff, the o-ring 92 is still deformable in the event that the brushless permanent magnet motor 1 experiences forces during abnormal use, for example as a result of the brushless permanent magnet motor 1 or a product in which the motor is installed being dropped. A distance between the first bearing 74 and a wall of the channel 104 in the first portion 120 is greater than a distance between the first bearing 74 and a wall of the channel 104 in the second portion 122. Similarly, the distance between the first bearing 74 and a wall of the channel 104 in the second portion 122 is greater than a distance between the permanent magnet 72 and a wall of the channel 104 in the third portion 124, and greater than a distance between the permanent magnet 72 and the pole faces 42,44 in the third portion 124. As a result, when the o-ring 92 is compressed during abnormal use, there is a risk that the permanent magnet 72 will contact the pole faces 42,44 or the wall of the channel 104 in the third portion 124, which can cause damage to the permanent magnet 72.

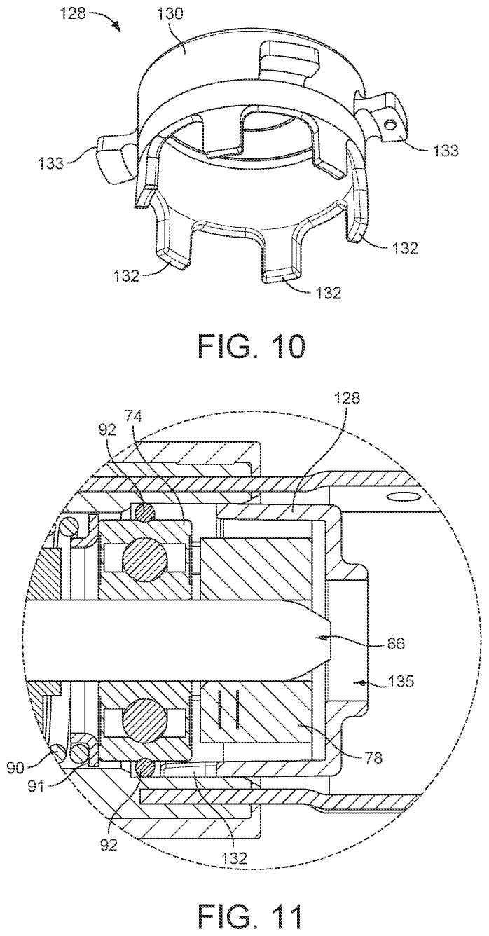

To avoid this happening, the brushless permanent magnet motor 1 has an end cap 128, which is shown in isolation in FIG. 10.

The end cap 128 comprises a main body 130, a plurality of fingers 132 extending from the main body 130, and a plurality of flanges 133 extending from the main body 128. The main body 130 is generally cylindrical in form, and hollow. The main body 130 overlies the inlet end 86 of the shaft 70 and the first balancing ring 78 when the brushless permanent magnet motor 1 is assembled. The plurality of fingers 132 are resiliently deformable, and, when not mounted to the brushless permanent magnet motor 1, the plurality of fingers 132 splay slightly outwardly from the main body 128. The plurality of fingers 132 extend from the main body 128 in a first direction, and the plurality of flanges 133 extend from the main body 128 in a second direction substantially orthogonal to the first direction. The plurality of flanges 133 engage the main body 94 of the frame 14 to prevent over-insertion of the end cap 128 into the frame 14.

An enlarged view of the end cap 128 located at the inlet end 86 of the shaft 70 is shown in FIG. 11.

The end cap 128 is located in the first portion 120 of the channel 104 such that the fingers 132 contact the wall of the first portion 120 of the channel 104 to retain the end cap 128 within the first portion 120. The plurality of fingers 132 are located between the first bearing 74 and the wall of the first portion 120 of the channel 104, with the plurality of fingers 132 spaced from the first bearing 74. A distance between the first bearing 74 and the plurality of fingers 132 is less than the distance between the permanent magnet 72 and a wall of the channel 104 in the third portion 124, and less than the distance between the permanent magnet 72 and the pole faces 42,44 in the third portion 124.

Thus in the event that the o-ring 92 is deformed when the brushless permanent magnet motor 1 experiences forces during abnormal use, the first bearing 74 contacts at least some of the plurality of fingers 132 before the permanent magnet 72 is able to contact the pole faces 42,44 or the wall of the channel 104 in the third portion 124. Thus the plurality of fingers 132 may act as a stopper to inhibit radial motion of the first bearing 74.

As depicted here, the end cap 128 comprises an aperture 135 through which the shaft 70 extends. In alternative embodiments, the end cap 128 may not comprise the aperture 135, which may facilitate creation of a sealed bearing cartridge. Similarly, the plurality of inlet cooling apertures 114 and the plurality of outlet cooling apertures 116 may be omitted where a sealed bearing cartridge is desirable. A sealed bearing cartridge may inhibit airflow from entering the region of the frame 14 in which the bearings 74,76 are housed in use, which may reduce emissions.

The brushless permanent magnet motor 1 further comprises a diffuser 134 located downstream of the impeller 84. The diffuser 134 is attached to the shroud 96 and comprises a plurality of vanes 136 for turning airflow as it passes through the diffuser 134 from the impeller 84 in use. Although depicted as a multi-stage diffuser, ie a diffuser with more than one row of vanes, it will be appreciated that other forms of diffuser, such as a single stage diffuser, are also envisaged.

In use, current is passed through the windings 24 of the stator assembly 10 to generate a magnetic field that interacts with the permanent magnet 72 to cause rotation of the rotor assembly 12, and hence rotation of the impeller 84. This causes air to be drawn into the brushless permanent magnet motor 1, where air interacts with the impeller 84 before exiting the brushless permanent magnet motor 1 via the diffuser 134.

Steps involved in manufacture of the brushless permanent magnet motor 1 will now be reiterated.

Each stator core sub-assembly 16 is assembled individually, with the bobbin 22 overmoulded to the stator core 20, and the winding 24 wound about the bobbin 22. Individual stator core sub-assemblies 16 are connected to one another via the first 50 and second 52 connection portions of the respective bobbins 22.

The sleeve 62 is overmoulded to the first 58 and second 60 terminals to define the termination assembly 18, and the windings 24 are fused to the first 58 and second 60 terminals. Collectively, the stator core sub-assemblies 16 and the termination assembly 18 define the stator assembly 10. The sleeve 62 and the bobbins 22 are formed from different materials, and are overmoulded to their respective components in separate overmoulding processes.

The frame 14 is overmoulded to the stator assembly 10 in a separate overmoulding process to each of those of the bobbins 22 and the sleeve 62, and the frame 14 is formed from the same material as the sleeve 62.

The rotor assembly 12 is inserted into the frame 14, and the end cap 128 is located over the inlet end 86 of the shaft 70.

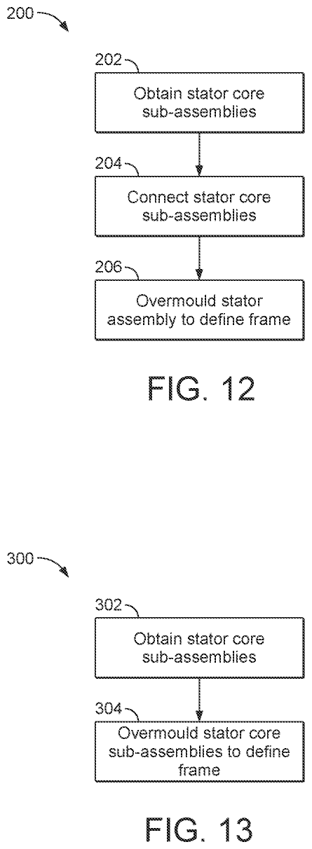

A first method 200 of manufacturing the brushless permanent magnet motor 1 is illustrated in the flow diagram of FIG. 12.

The method 200 comprises obtaining 202 the plurality of stator core sub-assemblies 16, connecting 204 adjacent stator core sub-assemblies 16 to form the stator assembly 10, and overmoulding 206 the stator assembly 10 to define the frame 14 within which the stator assembly 10 is housed.

By overmoulding the stator assembly 10 to define the frame 14, the need for the stator core sub-assemblies 16 to be individually adhered to the frame 14 may be removed, and this may provide a manufacturing process with fewer steps than a manufacturing process in which the stator core sub-assemblies 16 are individually adhered to the frame 14.

Overmoulding the frame 14 to the stator assembly 10 may, in some examples, provide increased thermal transfer from the stator core sub-assemblies 16 to the frame 14 compared to embodiments where stator core sub-assemblies 16 are adhered to the frame 14.

Overmoulding the frame 14 to the stator assembly 10 may provide a brushless permanent magnet motor 1 having a greater overall stiffness than, for example, a brushless permanent magnet motor in which the stator core sub-assemblies are individually adhered to the frame. Overmoulding the frame 14 to the stator assembly 10 may also facilitate manufacture of a brushless motor having a generally sealed bearing cartridge compared to, for example, an arrangement where the frame has apertures into which individual stator core sub-assemblies are mounted. A sealed bearing cartridge may inhibit airflow from entering the region of the frame 14 in which the bearings 74,76 are housed in use, which may reduce emissions.

A second method 300 of manufacturing the brushless permanent magnet motor 1 is illustrated in the flow diagram of FIG. 13.

The method 300 comprises obtaining 302 the plurality of stator core sub-assemblies 16, and overmoulding 304 the plurality of stator core sub-assemblies 16 to define the frame 14 such that at least a portion of the back 26 and the first 28 and second 30 arms of each stator core 20 is exposed through the frame 14.

As above, by overmoulding the stator core sub-assemblies 16 to define the frame 14, the need for the stator core sub-assemblies 16 to be individually adhered to the frame 14 may be removed, and this may provide a manufacturing process with fewer steps than a manufacturing process in which the stator core sub-assemblies 16 are individually adhered to the frame 14. Overmoulding the frame 14 to the stator core sub-assemblies 16 may, in some examples, provide increased thermal transfer from the stator core sub-assemblies 16 to the frame 14 compared to embodiments where stator core sub-assemblies 16 are adhered to the frame 14.

Overmoulding the frame 14 to the stator core sub-assemblies 16 may provide a brushless permanent magnet motor 1 having a greater overall stiffness than, for example, a brushless permanent magnet motor in which the stator core sub-assemblies are individually adhered to the frame.

However, overmoulding of the stator core sub-assemblies 16 may remove the stator core sub-assemblies 16 from a region of airflow through the brushless permanent magnet motor 1 in use, which may result in the stator cores 22 and/or the windings 24 experiencing increased temperatures in use. By overmoulding the frame 14 to stator core sub-assemblies 16 such that at least a portion of the back 26 and the first 28 and second 30 arms of each stator core 22 is exposed through the frame 14, at least a portion of each stator core 22 may be exposed to airflow through the brushless permanent magnet motor lin use, which may provide a cooling effect, thereby reducing any increases in temperature experienced as a result of the overmoulding of the stator core sub-assemblies 16.

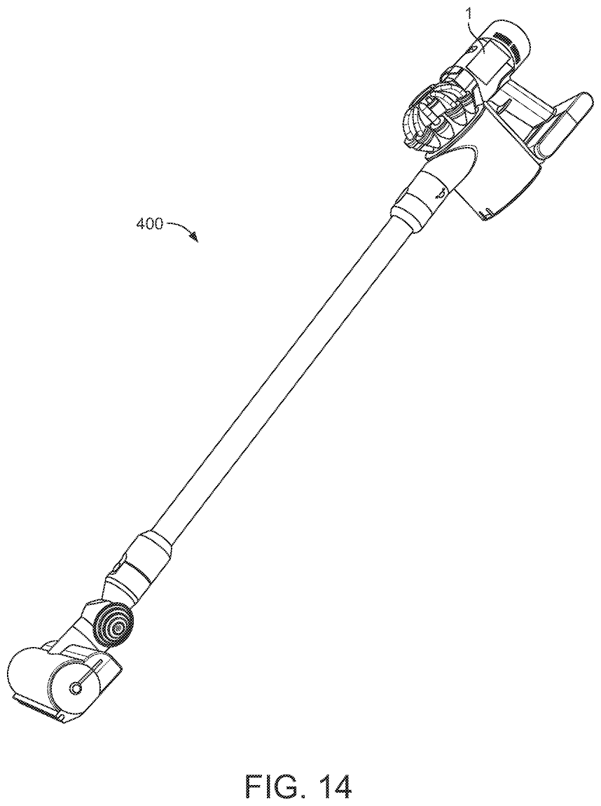

The brushless permanent magnet motor 1 described herein may find particular utility in fields where small factor yet high power density is desirable. As an example, a vacuum cleaner comprising the brushless permanent magnet motor is illustrated schematically in FIG. 14.

Although described herein with a combination of features, it will be appreciated that embodiments of the brushless motor 1 where only some of the above-mentioned features are implemented are also envisaged. For example, the turbulators 112 may still find utility in an arrangement in which the shoulders of the stator cores 22 are not exposed by the frame 14.

1. A brushless motor comprising a stator assembly, a rotor assembly, and a frame within which the stator assembly is housed, wherein the stator assembly comprises a plurality of stator core sub-assemblies each comprising a stator core, a bobbin attached to the stator core, and a winding wound about the bobbin, wherein the frame is overmoulded to the stator assembly; the frame comprises a plurality of apertures for introducing airflow to the rotor assembly in use.

2. The brushless motor as claimed in claim 1, wherein the plurality of apertures comprises an inlet aperture located at an inlet of the frame and an outlet aperture located at an outlet end of the frame.

3. The brushless motor as claimed in claim 2, wherein the inlet aperture is located downstream of a first bearing and the outlet aperture is located upstream of a second bearing.

4. The brushless motor as claimed in claim 1, wherein each stator core comprises a back and first and second arms extending from the back, such that at least a portion of the back and the first and second arms of each stator core is exposed through the frame.

5. The brushless motor as claimed in claim 4, wherein at least 10% of each stator core is exposed through the frame.

6. The brushless motor as claimed in claim 4, wherein no more than 30% of each stator core is exposed through the frame.

7. The brushless permanent magnet motor as claimed in claim 1, wherein the frame comprises a plurality of turbulators.

8. The brushless motor as claimed in claim 7, wherein the turbulators are formed during a process of over-moulding the frame to the stator assembly.

9. The brushless motor as claimed in claim 7, wherein the plurality of turbulators overlie the backs of the stator cores.

10. The brushless motor as claimed in claim 7, wherein the plurality of turbulators are obliquely angled relative to an axis substantially parallel to a central longitudinal axis of the brushless motor.

11. The brushless motor as claimed in claim 10, wherein the plurality of turbulators are angled between 45-75 degrees relative to the axis.

12. The brushless motor as claimed in claim 11, wherein the plurality of turbulators are angled at around 60 degrees relative to the axis.

13. The brushless motor as claimed in claim 10, wherein the trailing end of each turbulator is closer to the axis than a leading end of the turbulator.

14. The brushless motor as claimed in claim 10, wherein a pitch to height ratio of each turbulator is in the region of 6:1 to 12:1.

15. The brushless motor as claimed in claim 14, wherein the pitch to height ratio of each turbulator is around 7:1.

16. The brushless motor as claimed in claim 7, wherein a height of each turbulator is in the region of 0.3-0.9 mm.

17. The brushless motor as claimed in claim 7, wherein the plurality of turbulators comprise a plurality of pairs of turbulators, each pair of turbulators arranged in a generally V-shaped formation.

18. The brushless motor as claimed in claim 1, wherein the frame comprises a main body having protrusions, each protrusion overlying a respective stator core, and each protrusion comprising a region of increased radius relative to regions of the main body between adjacent stator cores of the stator assembly.

19. The brushless motor as claimed in claim 1, wherein the frame comprises a plurality of struts, each strut extending from a respective region of the frame overlying a core back to a shroud of the frame.

20. The brushless motor as claimed in claim 19 wherein each of the plurality of struts overlies a winding, and a leading end of each strut is substantially aligned with a leading edge of the winding which the strut overlies.

21. The brushless motor as claimed in claim 1, wherein the frame comprises a plurality of grooves formed in an outer surface of the frame for guiding airflow into the plurality of apertures.

22. A vacuum cleaner comprising the brushless motor as claimed in claim 1.
